(19) United States
(12) Patent Application Publication
(10) Pub. No.: US 2026/0152419 A1
(43) Pub. Date: Jun. 4, 2026

(54) COMPOSITE ELECTRODE

(71) Applicant: Ming Chi University of Technology, New Taipei City (TW)

(72) Inventors: Yi-Ting LAI, New Taipei City (TW); Da-Wei HUANG, New Taipei City (TW)

(21) Appl. No.: 19/070,847

(22) Filed: Mar. 5, 2025

(30) Foreign Application Priority Data
Nov. 29, 2024 (TW) 113146261

(51) Int. Cl. C02F 1/469; C02F 1/28; C02F 101/10

(52) U.S. Cl. CPC C02F 1/469; C02F 1/288; C02F 1/281; C02F 1/283; C02F 1/285; C02F 2101/105; C02F 2303/16

(57) ABSTRACT

A composite electrode for absorbing and desorbing phosphates in a liquid includes a carrier, and a composite laminated structure including a layered double hydroxide unit which includes at least two layered double hydroxide layers, and an azobenzene unit which includes at least one azobenzene layer. The at least one azobenzene layer of the azobenzene unit contains an azobenzene component. When the azobenzene unit is subjected to irradiation with an ultraviolet light, the azobenzene component in the at least one azobenzene layer of the azobenzene unit has a cis-structure, so that the composite laminated structure is in an absorption state. When the azobenzene unit is subjected to irradiation with a visible light, the azobenzene component in the at least one azobenzene layer of the azobenzene unit has a trans-structure, so that the composite laminated structure is in a desorption state.

### CROSS-REFERENCE TO RELATED APPLICATION

This application claims priority to Taiwanese Invention Patent Application No. 113146261, filed on Nov. 29, 2024, the entire disclosure of which is incorporated by reference herein.

### FIELD

The disclosure relates to a composite electrode for absorbing and desorbing phosphates in a liquid.

### BACKGROUND

Treating phosphates in wastewater to reduce various hazards caused by the phosphates to the environment has always been an issue that all parties is trying to solve. There are various methods to treat phosphates in wastewater, and one of them is by adding layered double hydroxides to the wastewater containing phosphates, followed by stirring the resultant mixture, so that the phosphates are absorbed by the layered double hydroxides, thereby removing the phosphates. However, the effectiveness of absorption and desorption of the phosphates using the layered double hydroxides is still in need of improvement. Moreover, the foregoing method requires not only a long time for the layered double hydroxides to absorb the phosphates, but also a long time to desorb the phosphates from the layered double hydroxides so as to recover the phosphates, such that entire process of the method usually takes up to 72 hours to complete, resulting in poor efficiency thereof.

Accordingly, those skilled in the art are committed to improving the effectiveness of the aforesaid method, i.e., to enhance the absorption and desorption of phosphates using the layered double hydroxides.

### SUMMARY

Therefore, an object of the disclosure is to provide a composite electrode for absorbing and desorbing phosphates in a liquid, which can alleviate at least one of the drawbacks of the prior art. The composite electrode includes:
a carrier; and
a composite laminated structure disposed on the carrier, and including a layered double hydroxide unit which includes at least two layered double hydroxide layers, and an azobenzene unit which includes at least one azobenzene layer, the at least one azobenzene layer being disposed between the at least two layered double hydroxide layers, the at least two layered double hydroxide layers being respectively a topmost layer and a bottommost layer of the composite laminated structure;
wherein the at least one azobenzene layer of the azobenzene unit contains an azobenzene component,
wherein when the azobenzene unit is subjected to irradiation with an ultraviolet light, the azobenzene component in the at least one azobenzene layer of the azobenzene unit has a cis-structure, so that the composite laminated structure is in an absorption state, and
wherein when the azobenzene unit is subjected to irradiation with a visible light, the azobenzene component in the at least one azobenzene layer of the azobenzene unit has a trans-structure, so that the composite laminated structure is in a desorption state.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic view illustrating a composite electrode of a first embodiment according to the present disclosure.

FIG. 2 is a schematic view illustrating a composite electrode of a second embodiment according to the present disclosure.

FIG. 3 is a schematic view illustrating a desorption state of a composite laminated structure of the composite electrode of the first embodiment or the second embodiment according to the present disclosure.

FIG. 4 is a schematic view illustrating an absorption state of the composite laminated structure of the composite electrode of the first embodiment or the second embodiment according to the present disclosure.

FIG. 5 is a graph illustrating characteristic peaks of X-ray diffraction patterns of a composite electrode of Preparative Example, a layered double hydroxide electrode of Comparative Preparative Example, and a magnesium-manganese layered double hydroxide powder, respectively.

FIG. 6 is a partially enlarged view taken from the boxed region in FIG. 5, illustrating the characteristic peaks of the X-ray diffraction patterns of the composite electrode of Preparative Example and the layered double hydroxide electrode of Comparative Preparative Example, respectively.

FIG. 7 is a field emission scanning electron microscope (FE-SEM) image illustrating a surface of the composite electrode of Preparative Example.

FIG. 8 is a transmission electron microscope (TEM) image of the composite electrode of Preparative Example.

FIG. 9 is an FE-SEM image illustrating a surface of the layered double hydroxide electrode of Comparative Preparative Example.

FIG. 10 is a TEM image illustrating the layered double hydroxide electrode of Comparative Preparative Example.

FIG. 11 is X-ray photoelectron spectroscopy (XPS) spectra illustrating a binding energy of manganese (Mn) 2p orbital of the composite electrode of Preparative Example and a binding energy of Mn 2p orbital of the layered double hydroxide electrode of Comparative Preparative Example, respectively.

FIG. 12 is XPS spectra illustrating a binding energy of magnesium (Mg) 2p orbital of the composite electrode of Preparative Example and a binding energy of Mg 2p orbital of the layered double hydroxide electrode of Comparative Preparative Example, respectively.

FIG. 13 is an XPS spectrum illustrating a binding energy of nitrogen (N) 1s orbital of the composite electrode of Preparative Example.

### DETAILED DESCRIPTION

It is to be understood that, if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

The present disclosure provides a composite electrode for absorbing and desorbing phosphates in a liquid. Examples of the liquid may include, but are not limited to, a prepared aqueous solution containing the phosphates, and a wastewater containing the phosphates.

The composite electrode of the present disclosure includes a carrier 1 and a composite laminated structure 2. In certain embodiments, the carrier 1 may be made of a material selected from the group consisting of a carbon material, an indium-tin-oxide conductive glass, and a combination thereof. In an exemplary embodiment, the material is the indium-tin-oxide conductive glass. In some embodiments, the carbon material may be a carbon felt. The composite laminated structure 2 is disposed on the carrier 1, and includes a layered double hydroxide unit 21 which includes at least two layered double hydroxide layers 211, and an azobenzene unit 22 which includes at least one azobenzene layer 221. The at least one azobenzene layer 221 is disposed between the at least two layered double hydroxide layers 211, and the at least two layered double hydroxide layers 211 are respectively a topmost layer and a bottommost layer of the composite laminated structure 2.

In certain embodiments, one of the at least two layered double hydroxide layers 211 of the layered double hydroxide unit 21, which is the bottommost layer of the composite laminated structure 2, may be in contact with the carrier 1. In certain embodiments, the one of the at least two layered double hydroxide layers 211, which is the bottommost layer of the composite laminated structure 2, may be formed on a surface of the carrier 1 by an in-situ growth, a layer-by-layer growth, or a co-precipitation process. In certain embodiments, each of the at least two layered double hydroxide layers 211 of the layered double hydroxide unit 21 may contain a layered double hydroxide component. Examples of the layered double hydroxide component may include, but are not limited to, magnesium-manganese layered double hydroxide, magnesium-aluminum layered double hydroxide, and another layered double hydroxide known to those skilled in the art which is capable of absorbing the phosphates. In certain embodiments, the layered double hydroxide component may be selected from the group consisting of magnesium-manganese layered double hydroxide, magnesium-aluminum layered double hydroxide, and a combination thereof. In an exemplary embodiment, in order to allow the composite laminated structure 2 to have a relatively high affinity for the phosphates, the layered double hydroxide component is the magnesium-manganese layered double hydroxide.

According to the present disclosure, the at least one azobenzene layer 221 of the azobenzene unit 22 contains an azobenzene component. In certain embodiments, the azobenzene component may include an azobenzene and a modifying group which is bonded to the azobenzene. According to the present disclosure, the modifying group is capable of increasing the hydrophilicity of the composite laminated structure 2 and enhancing the hydrogen bonding force between the composite laminated structure 2 and the phosphates. Examples of the modifying group may include, but are not limited to, —OH, —COOH, and a sulfonamide group. In certain embodiments, the modified group may be selected from the group consisting of —OH, —COOH, the sulfonamide group, and combinations thereof.

According to the present disclosure, when the azobenzene unit 22 is subjected to irradiation with an ultraviolet light, the azobenzene component in the at least one azobenzene layer 221 of the azobenzene unit 22 has a cis-structure, so that the composite laminated structure 2 is in an absorption state. When the azobenzene unit 22 is subjected to irradiation with a visible light, the azobenzene component in the at least one azobenzene layer 221 of the azobenzene unit 22 has a trans-structure, so that the composite laminated structure 2 is in a desorption state. In certain embodiments, the ultraviolet light may have a wavelength ranging from 365 nm to 366 nm. In certain embodiments, the visible light may have a wavelength greater than 400 nm.

The composite electrode of the present disclosure are further illustrated by the following first embodiment and second embodiment.

### First Embodiment

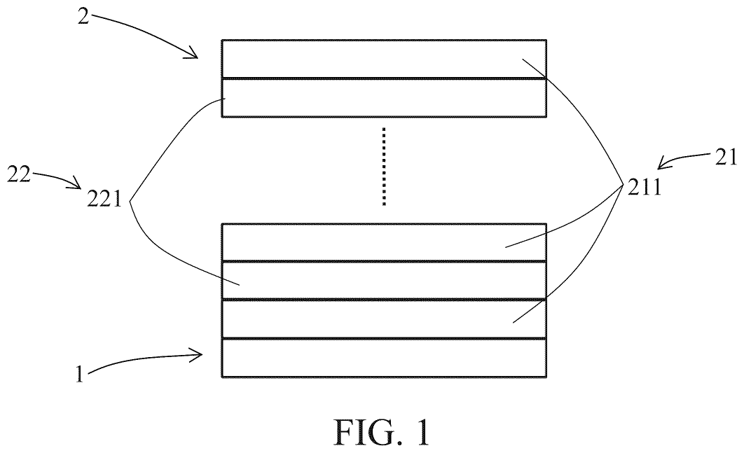

Referring to FIG. 1, a first embodiment of a composite electrode of the present disclosure includes the carrier 1 and the composite laminated structure 2, which includes the layered double hydroxide unit 21 and the azobenzene unit 22. The layered double hydroxide unit 21 includes a plurality of layered double hydroxide layers 211, and the azobenzene unit 22 includes a plurality of azobenzene layers 221. In addition, a total number of the plurality of layered double hydroxide layers 211 is greater than a total number of the plurality of azobenzene layers 221. Each of the plurality of azobenzene layers 221 is disposed between two adjacent ones of the plurality of layered double hydroxide layers 211. That is to say, the plurality of layered double hydroxide layers 211 and the plurality of azobenzene layers 221 are alternately stacked in a direction away from the carrier 1, and two of the plurality of layered double hydroxide layers 211 are respectively a topmost layer and a bottommost layer of the composite laminated structure 2. Moreover, a thickness of one of the plurality of azobenzene layers 221 when the composite laminated structure 2 is in the absorption state, is less than a thickness of the one of the plurality of azobenzene layers 221 when the composite laminated structure 2 is in the desorption state. In other words, a distance between two adjacent ones of the plurality of layered double hydroxide layers 211 when the composite laminated structure 2 is in the adsorption state, is less than a distance between the two adjacent ones of the plurality of layered double hydroxide layers 211 when the composite laminated structure 2 is in the desorption state.

### Second Embodiment

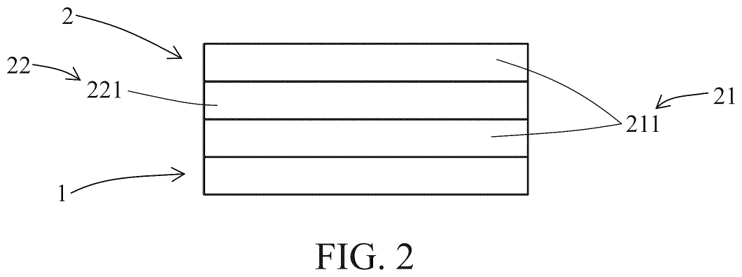

Referring to FIG. 2, a second embodiment of the composite electrode of the present disclosure includes the carrier 1 and the composite laminated structure 2 which includes the layered double hydroxide unit 21 and the azobenzene unit 22. The layered double hydroxide unit 21 includes two layered double hydroxide layers 211, and the azobenzene unit 22 includes an azobenzene layer 221. The azobenzene layer 221 is disposed between the two layered double hydroxide layers 211. Moreover, a thickness of the azobenzene layer 221 when the composite laminated structure 2 is in the absorption state, is less than a thickness of the azobenzene layer 221 when the composite laminated structure 2 is in the desorption state. In other words, a distance between the two layered double hydroxide layers 211 when the composite laminated structure 2 is in the adsorption state is less than a distance between the two layered double hydroxide layers 211 when the composite laminated structure 2 is in the desorption state.

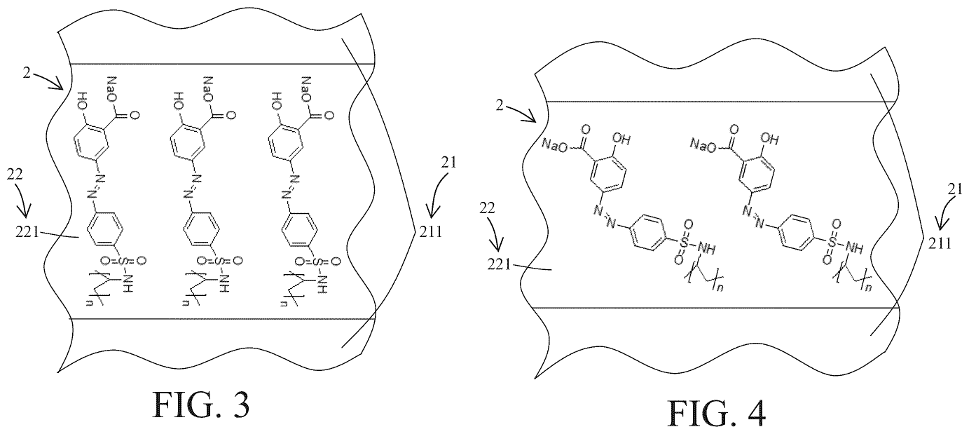

FIGS. 3 and 4 illustrate a structural change of the azobenzene component when the composite laminated structure 2 in the adsorption state is altered to be in the desorption state. The composite laminated structure 2 is in the absorption state when the azobenzene unit 22 is subjected to irradiation with the ultraviolet light. In this case, the azobenzene component in the at least one azobenzene layer 221 of the azobenzene unit 22 is transformed from the trans-structure (as shown in FIG. 3) to the cis-structure (as shown in FIG. 4), so that the thickness of the each of the at least one azobenzene layer 221 is reduced, and hence, the distance between two adjacent ones of the at least two layered double hydroxide layers 211 is reduced, which allows the phosphates absorbed by the composite laminated structure 2 to be less likely to escapes therefrom, thus attaining a good absorption effect. In contrast, the composite laminated structure 2 is in the desorption state when the azobenzene unit 22 is subjected to irradiation with the visible light. In this case, the azobenzene component in the at least one azobenzene layer 221 of the azobenzene unit 22 is transformed from the cis-structure (as shown in FIG. 4) to the trans-structure (as shown in FIG. 3), so that the thickness of the each of the at least one azobenzene layer 221 is increased, and hence, the distance between two adjacent ones of the at least two layered double hydroxide layers 211 is increased, which allows the phosphates absorbed by the composite laminated structure 2 to be easily detached therefrom, thus attaining a good desorption effect. Therefore, by virtue of irradiating the azobenzene unit 22 with the ultraviolet light or the visible light, the composite laminated structure 2 is capable of converting between the absorption state and the desorption state, thereby providing the composite electrode of the present disclosure with enhanced capability of absorbing and desorbing the phosphates.

According to the present disclosure, the composite electrode may be prepared by the following procedures. First, a suitable amount of magnesium chloride, manganese (II) chloride and sodium carbonate are dissolved in water to form a precursor solution for producing a layered double hydroxide layer 211. Next, a suitable amount of poly [1-[4-(3-carboxy-4-hydroxyphenylazo)benzenesulfonamido]-1,2-ethanediyl, sodium salt] is dissolved in water to form a precursor solution for producing an azobenzene layer 221. Subsequently, the carrier 1, the precursor solution for producing the layered double hydroxide layer 211 and the precursor solution for producing the azobenzene layer 221 are placed in a three-electrode electrochemical assembly, followed by conducting an electrochemical reaction, so that one of the at least two layered double hydroxide layers 211 is formed on the carrier 1 (i.e., on the bottom of the composite laminated structure 2), another one of the at least two layered double hydroxide layers 211 is formed as the topmost layer of the composite laminated structure 2, and the at least one azobenzene layer 221 is formed between the at least two layered double hydroxide layers 211, thereby obtaining the composite electrode of the present disclosure.

According to the present disclosure, by virtue of the layered double hydroxide unit 21 (which includes the at least two layered double hydroxide layers 211) and the azobenzene unit 22 (which includes the at least one azobenzene layer 221), the composite electrode of the present disclosure is capable of absorbing the phosphates in the liquid when a positive voltage and irradiation of ultraviolet light are applied, and is capable of desorbing the phosphates that are absorbed by the same when a negative voltage and irradiation of visible light are applied, thereby achieving good phosphate absorption and desorption effects, as well as good phosphate treatment efficiency.

The present disclosure will be further described by way of the following examples. However, it should be understood that the following examples are intended solely for the purpose of illustration and should not be construed as limiting the present disclosure in practice.

### EXAMPLES

### Preparative Example

### Preparation of Composite Electrode of the Present Disclosure

First, a suitable amount of poly [1-[4-(3-carboxy-4-hydroxyphenylazo)benzenesulfonamido]-1,2-ethanediyl, sodium salt] (PAZO; UNI-ONWARD CORP.; serving as an azobenzene component) was evenly mixed with 100 ml of deionized water, so as to obtain a first precursor solution with the poly [1-[4-(3-carboxy-4-hydroxyphenylazo)benzenesulfonamido]-1,2-ethanediyl, sodium salt] present in an amount of 0.025 wt % based on 100 wt % of the first precursor solution. Next, a suitable amount of magnesium chloride, manganese (II) chloride and sodium carbonate were evenly mixed with 200 ml of deionized water, so as to obtain a second precursor solution with the magnesium chloride having a concentration of 0.03 M, the manganese (II) chloride having a concentration of 0.01 M, and the sodium carbonate having a concentration of 0.15 M. Thereafter, a piece of indium-tin-oxide conductive glass (UNI-ONWARD Corp.; Model: UR-ITO007) was used to serve as a carrier 1, and then a portion of a surface area of the piece of indium-tin-oxide conductive glass was covered with a corrosion-resistant insulating tape (3M Company; Model: 1182), and a remaining portion of the surface area, which had a length of 1 cm and a width of 1 cm on the piece of indium-tin-oxide conductive glass, served as a reaction area. After that, the piece of indium-tin-oxide conductive glass with such reaction area was placed in a three-electrode electrochemical assembly (Metrohm; Model: Autolab M204), followed by adjusting the distance between a working electrode and a counter electrode of the three-electrode electrochemical assembly to 1 cm. Subsequently, the reaction area of the piece of indium-tin-oxide conductive glass was subjected to 20 rounds of electrochemical reaction using the first precursor solution and the second precursor solution, so as to form layered double hydroxide layers 211, which were derived from the second precursor solution, and azobenzene layers 221, which were derived from the first precursor solution. The thus formed layered double hydroxide layers 211 and the azobenzene layers 221 were alternately stacked on each other in a direction away from the carrier 1. Specifically, in each of the 20 rounds of the electrochemical reaction, initially, a first fixed voltage of −1.25 V was applied for 50 seconds, so as to allow the second precursor solution to form one of the layered double hydroxide layers 211 on the reaction area of the piece of indium-tin-oxide conductive glass. After voltage conversion, a second fixed voltage of 0.2 V was applied for 5 seconds, so as to allow the first precursor solution to form one of the azobenzene layers 221 on the one of the layered double hydroxide layers 211 opposite to the reaction area. Upon completion of the 20 rounds of the electrochemical reaction, voltage conversion was performed, and a third fixed voltage of −1.25 V was applied for 50 seconds, thus allowing the second precursor solution to form a layered double hydroxide layer 211 on top of one of the azobenzene layers 221 that is farthest from the reaction area of the piece of indium-tin-oxide conductive glass. In this way, each of the azobenzene layers 221 was disposed between two adjacent ones of the layered double hydroxide layers 211, thereby obtaining a composite electrode of Preparative Example. In the composite electrode of Preparative Example, a total number of the layered double hydroxide layers 211, which together served as a layered double hydroxide unit 21, was 21, a total number of the azobenzene layers 221, which together served as an azobenzene unit 22, was 20, and the layered double hydroxide unit 21 and the azobenzene unit 22 together formed a composite laminated structure 2 that is disposed on the piece of indium-tin-oxide conductive glass.

### Comparative Preparative Example

### Preparation of Layered Double Hydroxide Electrode

The procedures for preparing a layered double hydroxide electrode of Comparative Preparative Example were similar to those described in Preparative Example, except that the first precursor solution was omitted, and in each of the 20 rounds of the electrochemical reaction, the second fixed voltage of 0.2 V was replaced by a voltage of 0 V after the voltage conversion (i.e., application of voltage was stopped for 5 seconds). In the layered double hydroxide electrode of Comparative Preparative Example, a total number of the layered double hydroxide layers 211 was 21, and azobenzene layers 221 were not formed.

### Property Evaluation

### <X-Ray Diffraction (XRD) Analysis>

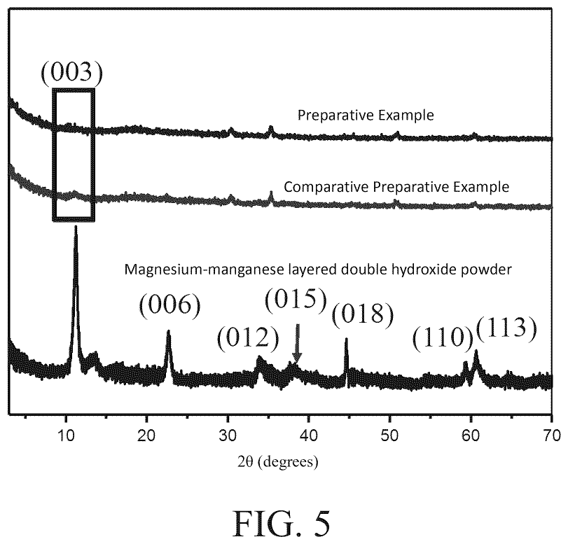

Each of the composite electrode of Preparative Example and the layered double hydroxide electrode of Comparative Preparative Example was subjected to XRD analysis using an X-ray diffractometer (Malvern Panalytical; Model: Empyrean), thereby obtaining XRD patterns of the same (see FIG. 5). Additionally, an XRD pattern of a magnesium-manganese layered double hydroxide powder was provided for comparison.

Referring to FIG. 5, a characteristic peak (as indicated by “(003)”) of the magnesium-manganese layered double hydroxide powder could be observed in the XRD pattern of each of the composite electrode of Preparative Example and the layered double hydroxide electrode of Comparative Preparative Example, demonstrating that both the composite electrode of Preparative Example and the layered double hydroxide electrode of Comparative Preparative Example indeed contained magnesium-manganese layered double hydroxides (which served as a layered double hydroxide component in the layered double hydroxide layers 211).

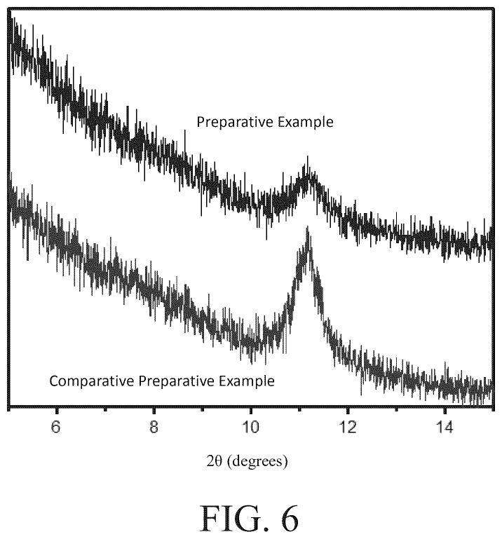

FIG. 6 is a partially enlarged view of the boxed region in FIG. 5. As shown in FIG. 6, the intensity of the characteristic peak in the XRD pattern of the composite electrode of Preparative Example was significantly lower than the intensity of the characteristic peak in the XRD pattern of the layered double hydroxide electrode of Comparative Preparative Example, indicating that formation of the azobenzene layers 221 by application of the second fixed voltage of 0.2 V would cause a small amount of the magnesium-manganese layered double hydroxides to undergo an oxidation reaction. These results demonstrated that in the composite electrode of Preparative Example, the azobenzene layers 221 including the azobenzene component were indeed inserted into the layered double hydroxide layers 211.

### <Morphological Analysis>

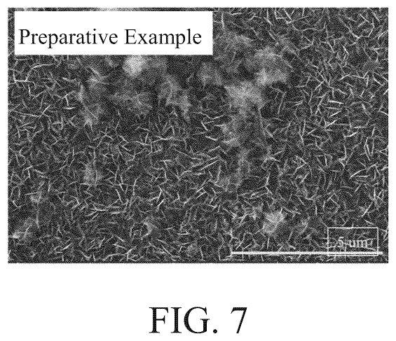

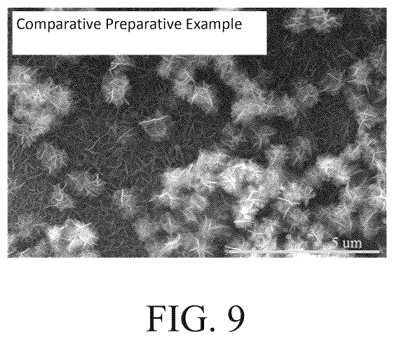

Each of the composite electrode of Preparative Example and the layered double hydroxide electrode of Comparative Preparative Example was subjected to a morphological analysis using a field emission scanning electron microscope (FE-SEM) (HITACHI; Model: S-5200). The thus obtained FE-SEM images of the composite electrode of Preparative Example and the layered double hydroxide electrode of Comparative Preparative Example were shown in FIGS. 7 and 9, respectively.

As shown in FIGS. 7 and 9, the composite electrode of Preparative Example had a surface with surface roughness greater than that of the layered double hydroxide electrode of Comparative Preparative Example.

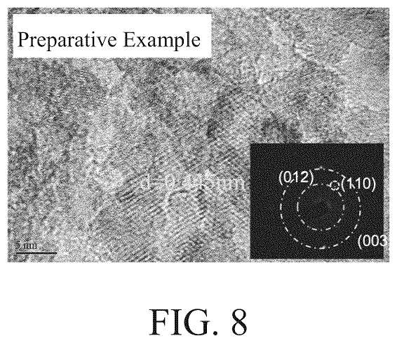

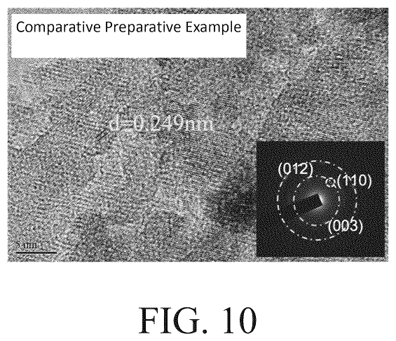

In addition, each of the composite electrode of Preparative Example and the layered double hydroxide electrode of Comparative Preparative Example was subjected to another morphological analysis using a transmission electron microscope (TEM) (JEOL; Model: JEM-2100 LaB6). The thus obtained TEM images of the composite electrode of Preparative Example and the layered double hydroxide electrode of Comparative Preparative Example were shown in FIGS. 8 and 10, respectively.

As shown in FIG. 8, two adjacent ones of the layered double hydroxide layers 211 had a distance therebetween of 0.445 nm. As shown in FIG. 10, two adjacent ones of the layered double hydroxide layers 211 had a distance therebetween of 0.249 nm. These results demonstrate that in the composite electrode of Preparative Example, the azobenzene layers 221 including the azobenzene component were indeed inserted into the layered double hydroxide layers 211, so that a spacing between the two adjacent ones of the layered double hydroxide layers 211 was increased.

### <Measurement of Absorbance Before and After Irradiation>

Before irradiation, the composite electrode of Preparative Example was subjected to measurement of absorbance using an ultraviolet-visible (UV-vis) spectrophotometer (Jasco; Model: V-650). Next, the composite electrode of Preparative Example was subjected to 3 rounds (namely, 1^{st} round, 2^{nd} round, and 3^{rd} round) of measurement of absorbance using the ultraviolet-visible (UV-vis) spectrophotometer (Jasco; Model: V-650). Each of the 3 rounds of measurement of absorbance was conducted as follows: first, the composite electrode of Preparative Example was subjected to irradiation with ultraviolet light having a wavelength of 365 nm for 60 minutes, and then subjected to measurement of absorbance at a wavelength of 465 nm (OD₄₆₅); subsequently, was subjected to irradiation with visible light having a wavelength greater than 400 nm for 5 minutes, followed by measurement of absorbance at a wavelength of 465 nm (OD₄₆₅). The thus obtained absorbance values for the composite electrode of Preparative Example are shown in Table 1 below.

TABLE 1

| | | | Time of | Absorbance |
|---|---|---|---|---|
| | | | irradiation | value |
| | | Irradiation light | (minutes) | (a.u.) |
| Before irradiation | | — | — | 0.273 |
| After | 1^{st} | Ultraviolet light | 60 | 0.111 |
| irradiation | round | Visible light | 5 | 0.325 |
| | 2^{nd} | Ultraviolet light | 60 | 0.102 |
| | round | Visible light | 5 | 0.225 |
| | 3^{rd} | Ultraviolet light | 60 | 0.108 |
| | round | Visible light | 5 | 0.225 |

Referring to Table 1, in each of the 3 rounds of measurement of absorbance, after the irradiation with the ultraviolet light for 60 minutes, the absorbance of the composite electrode of Preparative Example decreased; however, after the irradiation with the visible light for 5 minutes, the absorbance of the same increased, indicating that the azobenzene component, which was contained in the azobenzene layers 221 of the composite electrode of Preparative Example, could reversibly switch between a cis-structure and a trans-structure depending on the type of the irradiation light. These results suggest that the composite electrode of Preparative Example can be repeatedly used for absorption and desorption of phosphates in a liquid.

### <Surface Roughness Analysis Before and After Irradiation>

Before irradiation, the composite electrode of Preparative Example was subjected to surface roughness analysis using an atomic force microscope (AFM) (Bruker; Model: Dimension Edge). Next, the composite electrode of Preparative Example was subjected to a first irradiation with ultraviolet light having a wavelength of 365 nm for 60 minutes, and subsequently to a second irradiation with visible light having a wavelength of 400 nm for 5 minutes. At each time point after the first irradiation and the second irradiation, the composite electrode of Preparative Example was also subjected to surface roughness analysis using the atomic force microscope (AFM) (Bruker; Model: Dimension Edge). The thus obtained surface roughness of the composite electrode of Preparative Example, which was measured before and after the first irradiation and the second irradiation, are shown in Table 2 below.

TABLE 2

After irradiation

| | Before | First | Second |
|---|---|---|---|
| | irradiation | irradiation | irradiation |
| Surface | 0.0613 | 0.0314 | 0.0437 |
| roughness | | | |
| (nm) | | | |

Referring to Table 2, after the first irradiation with the ultraviolet light for 60 minutes, the surface roughness (i.e., 0.0314 nm) of the composite electrode of Preparative Example significantly decreased compared to the surface roughness (i.e., 0.0613 nm) of the same before the irradiation with the ultraviolet light; however, after the second irradiation with the visible light for 5 minutes, which was followed by the first irradiation, the surface roughness (i.e., 0.0437 nm) of the composite electrode of Preparative Example significantly increased compared to the surface roughness (i.e., 0.0314 nm) of the same after the first irradiation with the ultraviolet light for 60 minutes. These results indicate that the surface of the composite electrode of Preparative Example would be altered due to the azobenzene component, which was contained in the azobenzene layers 221 of the composite electrode of Preparative Example, being converted between the cis-structure and the trans-structure due to irradiation with different types of light.

### <X-Ray Photoelectron Spectroscopy (XPS) Analysis>

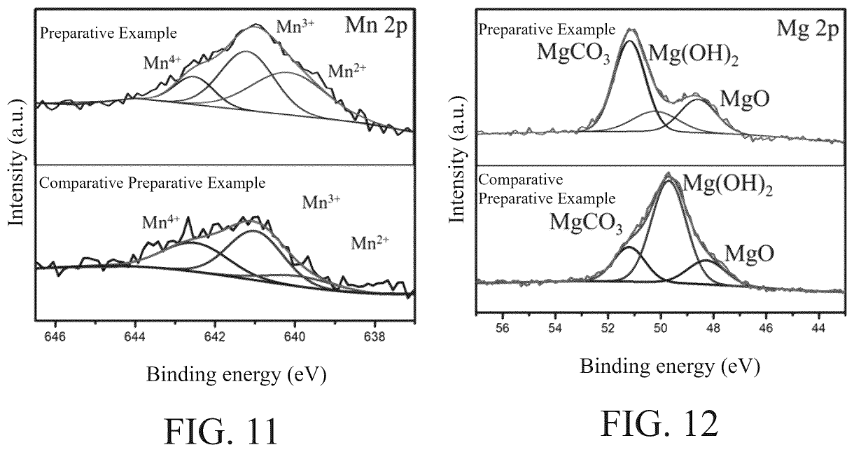

Each of the composite electrode of Preparative Example and the layered double hydroxide electrode of Comparative Preparative Example was subjected to XPS analysis using an x-ray photoelectron spectrometer (ULVAC-PHI. Inc.; Model: PHI 5000 VersaProbe), thereby obtaining XPS spectra of the composite electrode of Preparative Example and the layered double hydroxide electrode of Comparative Preparative Example shown in FIGS. 11 to 13.

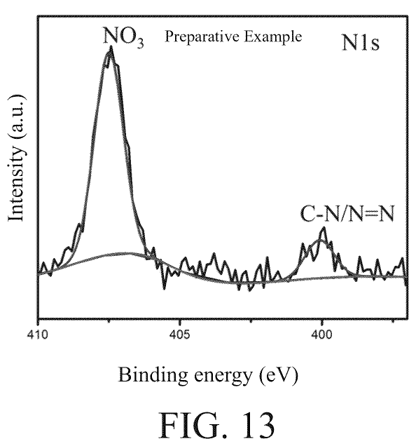

Referring to FIG. 11, during the formation of the azobenzene layers 221 by the application of the second fixed voltage of 0.2 V, manganese (Mn) ions in the magnesium-manganese layered double hydroxides would undergo the oxidation reaction, causing the peak position of a binding energy of Mn 2p orbital of the composite electrode of Preparative Example to be left-shifted at a greater extent than the peak position of a binding energy of Mn 2p orbital of the layered double hydroxide electrode of Comparative Preparative Example, and the valence of the Mn ions was increased. Referring to FIG. 12, because the poly [1-[4-(3-carboxy-4-hydroxyphenylazo)benzenesulfonamido]-1,2-ethanediyl, sodium salt] used for forming the azobenzene layers 221 contained carboxyl groups, and because the carboxyl groups, together with magnesium ions in the magnesium-manganese layered double hydroxides, formed magnesium carbonate (MgCO₃), an amount of MgCO₃ present in the composite electrode of Preparative Example was greater than an amount of MgCO₃ present in the layered double hydroxide electrode of Comparative Preparative Example. Referring to FIG. 13, because the poly [1-[4-(3-carboxy-4-hydroxyphenylazo)benzenesulfonamido]-1,2-ethanediyl, sodium salt] used for forming the azobenzene layers contained nitrogen-nitrogen double bonds (N═N), the composite electrode of Preparative Example had a characteristic peak at the binding energy of about 400.0 eV (which was assigned to the N═N binding energy). The results demonstrated that in the composite electrode of Preparative Example, the azobenzene layers 221 including the azobenzene component were indeed inserted into the layered double hydroxide layers 211.

### Phosphate Absorption/Desorption Test

### EXAMPLE

The composite electrode of Preparative Example was subjected a phosphate absorption test and a phosphate desorption test as follows. In the phosphate absorption test, the composite electrode of Preparative Example was immersed in 20 ml of a phosphate solution containing phosphates having a concentration of 100 ppm, followed by applying a direct-current (DC) voltage of 1 V to the composite electrode of Preparative Example, and simultaneously subjecting the same to irradiation with ultraviolet light having a wavelength of 365 nm for 60 minutes. After that, the composite electrode of Preparative Example was subjected to the phosphate desorption test by immersing in 20 ml of a solution containing sodium hydroxide and sodium chloride each having a concentration of 0.1 M, followed by applying an alternating-current (AC) voltage of −2 V with a frequency of 10 KHz to the composite electrode of Preparative Example, and simultaneously subjecting the same to irradiation with visible light having a wavelength greater than 400 nm for 60 minutes.

### Comparative Examples 1 and 2

The procedures for conducting the phosphate absorption test and the phosphate desorption test in each of Comparative Examples 1 and 2 were similar to those described in Example, except that in Comparative Example 1, the visible light having a wavelength greater than 400 nm was used in the phosphate absorption test, and in Comparative Example 2, the ultraviolet light having a wavelength of 365 nm was used in the phosphate desorption test as shown in Table 3 below.

### Comparative Example 3

The procedures for conducting the phosphate absorption test and the phosphate desorption test in Comparative Example 3 were similar to those described in Example, except that the layered double hydroxide electrode of Comparative Preparative Example was subjected to the phosphate absorption test and the phosphate desorption test, and the visible light having a wavelength greater than 400 nm was used in the phosphate absorption test as shown in Table 3 below.

TABLE 3

| | | Comparative | Comparative | Comparative |
|---|---|---|---|---|
| | Example | Example 1 | Example 2 | Example 3 |
| Electrode | Composite | Composite | Composite | Layered double |
| | electrode of | electrode of | electrode of | hydroxide |
| | Preparative | Preparative | Preparative | electrode of |
| | Example | Example | Example | Comparative |

Preparative
Example

Phosphate absorption test

| | | | | | | | | |
|---|---|---|---|---|---|---|---|---|
| DC voltage | 1 | V | 1 | V | 1 | V | 1 | V |

| | | | | |
|---|---|---|---|---|
| Irradiation | Ultraviolet | Visible | Ultraviolet | Visible |
| light | light | light | light | light |

Phosphate desorption test

| | | | | | | | | |
|---|---|---|---|---|---|---|---|---|
| AC voltage | −2 | V | −2 | V | −2 | V | −2 | V |

| | | | | |
|---|---|---|---|---|
| Irradiation | Visible | Visible | Ultraviolet | Visible |
| light | light | light | light | light |

The phosphate absorption capacity in each of Example, and Comparative Examples 1 to 3 was calculated using the following Equation (1):

$$A = ( {C}_{i} - {C}_{p} ) \times V / W \qquad ( 1 )$$

where A=phosphate absorption capacity in each example
   Cᵢ=concentration of phosphates in phosphate solution before phosphate absorption test
   Cₚ=concentration of phosphates in phosphate solution after phosphate absorption test
   V=volume of phosphate solution
   W=weight of composite electrode of Preparative

### Example/Layered Double Hydroxide Electrode of Comparative Preparative

### Example Excluding Weight of Carrier

The results were shown in Table 4 below.

The phosphate desorption capacity in each of Example, and Comparative Examples 1 to 3 was calculated using the following Equation (2):

$$B = ( {C}_{d} - {C}_{r} ) \times V / W \qquad ( 2 )$$

where B=phosphate desorption capacity in each example
   C_{d}=concentration of phosphates in solution after phosphate desorption test
   Cᵣ=concentration of phosphates in solution before phosphate desorption test
   V=volume of solution
   W=weight of composite electrode of Preparative

### Example/Layered Double Hydroxide Electrode of Comparative Preparative

### Example Excluding Weight of Carrier

The results were shown in Table 4 below.

The phosphate desorption rate in each of Example, and Comparative Examples 1 to 3 was calculated using the following Equation (3):

$$D = ( B / A ) \times 100 \% \qquad ( 3 )$$

where D=phosphate desorption rate

The results were shown in Table 4 below.

TABLE 4

| | | | Comparative | | Comparative | | Comparative | |
|---|---|---|---|---|---|---|---|---|
| | Example | | Example 1 | | Example 2 | | Example 3 | |
| Phosphate | 41.8 | (mg/g) | 28.1 | (mg/g) | 39.4 | (mg/g) | 33.6 | (mg/g) |
| absorption | | | | | | | | |
| capacity | | | | | | | | |
| Phosphate | 15.55 | (mg/g) | 4.95 | (mg/g) | 4.06 | (mg/g) | 10.15 | (mg/g) |
| desorption | | | | | | | | |
| capacity | | | | | | | | |
| Phosphate | 37.2 | (%) | 17.6 | (%) | 10.3 | (%) | 30.2 | (%) |
| desorption | | | | | | | | |
| rate | | | | | | | | |

Referring to Tables 3 and 4, the phosphate absorption capacity determined in each of Example and Comparative Example 2 was relatively high, indicating that use of the composite electrode of Preparative Example in combination with application of a positive voltage (i.e., the DC voltage of 1 V) and irradiation of the ultraviolet light allowed the composite electrode of Preparative Example to absorb a large amount of the phosphates contained in the phosphate solution. In addition, the phosphate desorption rate determined in Example was relatively high, indicating that use of the composite electrode of Preparative Example in combination with application of a negative voltage (i.e., the AC voltage of −2 V) and the irradiation of the visible light allowed the composite electrode of Preparative Example to desorb a large amount of the phosphates.

In summary, by virtue of the layered double hydroxide unit 21 (which includes the layered double hydroxide layers 211) and the azobenzene unit 22 (which includes the azobenzene layers 221), the composite electrode of the present disclosure is capable of absorbing phosphates in a liquid when positive voltage (i.e., DC voltage of 1 V) and irradiation of the ultraviolet light are applied. In this case, the azobenzene component contained in the azobenzene layers 221 of the azobenzene unit 22 has the cis-structure, so that the composite laminated structure 2 (which includes the layered double hydroxide unit 21 and the azobenzene unit 22) is in an absorption state. In addition, the composite electrode of the present disclosure is capable of desorbing the phosphates absorbed by the same when negative voltage (i.e., AC voltage of −2 V) and irradiation of the visible light are applied. In this case, the azobenzene component contained in the azobenzene layers 221 of the azobenzene unit 22 has the trans-structure, so that the composite laminated structure 2 is in a desorption state. Since the composite electrode of the present disclosure has both high phosphate absorption capacity and high phosphate desorption rate, the composite electrode of the present disclosure is capable of effectively processing the phosphates in the phosphate solution. Furthermore, by using the composite electrode of the present disclosure, adsorption and desorption of the phosphates can be completed in a relatively short period of time, indicating that the composite electrode of the present disclosure has an improved phosphate treatment efficiency, thereby achieving the purpose of the invention.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A composite electrode for absorbing and desorbing phosphates in a liquid, comprising:
a carrier, and
a composite laminated structure disposed on the carrier, and including a layered double hydroxide unit which includes at least two layered double hydroxide layers, and an azobenzene unit which includes at least one azobenzene layer, the at least one azobenzene layer being disposed between the at least two layered double hydroxide layers, the at least two layered double hydroxide layers being respectively a topmost layer and a bottommost layer of the composite laminated structure;
wherein the at least one azobenzene layer of the azobenzene unit contains an azobenzene component,
wherein when the azobenzene unit is subjected to irradiation with an ultraviolet light, the azobenzene component in the at least one azobenzene layer of the azobenzene unit has a cis-structure, so that the composite laminated structure is in an absorption state, and
wherein when the azobenzene unit is subjected to irradiation with a visible light, the azobenzene component in the at least one azobenzene layer of the azobenzene unit has a trans-structure, so that the composite laminated structure is in a desorption state.

2. The composite electrode as claimed in claim 1, wherein each of the at least two layered double hydroxide layers of the layered double hydroxide unit contains a layered double hydroxide component selected from the group consisting of magnesium-manganese layered double hydroxide, magnesium-aluminum layered double hydroxide, and a combination thereof.

3. The composite electrode as claimed in claim 1, wherein the azobenzene component includes an azobenzene and a modifying group which is bonded to the azobenzene, the modifying group being selected from the group consisting of —OH, —COOH, a sulfonamide group, and combinations thereof.

4. The composite electrode as claimed in claim 1, wherein the ultraviolet light has a wavelength ranging from 365 nm to 366 nm.

5. The composite electrode as claimed in claim 1, wherein the visible light has a wavelength greater than 400 nm.

6. The composite electrode as claimed in claim 1, wherein the carrier is made of a material selected from the group consisting of a carbon material, an indium-tin-oxide conductive glass, and a combination thereof.

7. The composite electrode as claimed in claim 6, wherein the carbon material is a carbon felt.
